(19) United States
(12) Patent Application Publication
(10) Pub. No.: US 2005/0195800 A1
(43) Pub. Date: Sep. 8, 2005

(54) Bandwidth efficiency central data center VoIP

(75) Inventors: Joseph Clifton Anders, Mobile, AL (US); Seacol Chin, Sugar Land, TX (US)

Correspondence Address: DORITY & MANNING, P.A., POST OFFICE BOX 1449, GREENVILLE, SC, 29602-1449, US

(73) Assignee: Global Tel*Link Corporation, Mobile, AL (US)

(21) Appl. No.: 11/030,008

(22) Filed: Jan. 5, 2005

Related U.S. Application Data
(60) Provisional application No. 60/534,490, filed on Jan. 6, 2004.

(51) Int. Cl. H04L 12/66

(52) U.S. Cl. 370/352

(57) ABSTRACT

The present subject matter is directed to apparatus and methodologies for providing improved voice over Internet Protocol (VoIP) bandwidth efficiency in specialized telecommunications systems. Improved efficiency is achieved by eliminating a significant portion of the “header” information normally associated with a VoIP data packet and replacing the header with a small byte count header designed only to identify a particular telecommunications instrument within the system. Because the specialized telecommunications system is designed to transmit the same type of data in the same format and to only one location, the conventionally supplied header information is unnecessary.

### PRIORITY CLAIM

This application claims the benefit of U.S. Provisional Application No. 60/534,490, entitled “IMPROVED BANDWIDTH EFFICIENCY CENTRAL DATA CENTER VoIP”, filed Jan. 6, 2004, which is incorporated herein by reference for all purposes.

### BACKGROUND OF THE INVENTION

The present technology relates generally to improved, specialized communications equipment, and more particularly in one aspect, although not exclusively, to the corrections environment.

Particularly within the corrections (or similarly institutionalized) environment, a need exists to provide telecommunications equipment for use by inmates or other detainees (or other individuals) that must provide not only controlled access to called parties but also other capabilities such as recording of selected individual conversations. It has been common practice for many years in the corrections environment to record and/or monitor inmates' conversations. Such recording and monitoring takes place in the very controlled conditions of permitted inmate communications with individuals outside of the facilities housing prisoners or inmates. Normally prisoners are limited to a small number of individuals that they are permitted to call. These may include family members and friends, and their lawyers, and may specifically exclude others, for example judges, jury members, witnesses, former co-conspirators and other like individuals to whom calls from a particular inmate may be of a harassing or other undesired nature. There may be time of day, length of call, three-way call or other restrictions on calls, all of which must be controlled by way of various instrumentalities that may include computer controlled equipment at the facility and/or at remote locations in addition to human monitoring and/or control. In almost all instances, such telephone calls must be recorded; yet even in those instances, there are conditions that may impact on the desire, ability, or legal right to record such conversations. For example, it is typically inappropriate to record or monitor conversations between an inmate and his/her attorney, and thus, measures must be taken to insure that, where calls are made from an inmate to his/her attorney, no recording is made and that no monitoring is allowed.

The particular needs described above have been addressed in the prior art, which, in major part, has provided responses to accommodate in one form or another the majority of the needs addressed. Examples of such include LazerPhone™ and LazerVoice® telecommunications products provided by the owner of the present subject matter. LazerPhone™ is a centralized, PC-based, integrated telephone system with features that provide control of inmate telecommunications activities. The system provides call blocking and monitoring, account control including personal identification number (PIN) setup and control, report generation including automated trouble reports, call activity reports and other administrative reports as well as numerous other features.

LazerVoice® is an optional feature of LazerPhone™ and provides a recording function for the LazerPhone™ system. LazerVoice® is a modular system that provides the ability to record at its installation site selected telephone conversations, to permit monitoring by appropriate authorities of selected conversations, and to achieve storing for later retrieval of recorded conversations. LazerVoice® provides other functions and operations involving the recording of telephone conversations. Additional information regarding these products may be found at the World Wide Web site, www.gtl.us, of the corporate owner of the present application interests.

An issue common to all of the above noted particular and exemplary environments is that of providing sufficient numbers of telecommunication instruments for individual use balanced with available transmission bandwidth for transmitting the voice (i.e., audio) data generated through the use of the telecommunications equipment. There are a number of technologies available that may be employed for such an effort ranging from ordinary analog telephone lines using the Public Switched Telephone Network (PSTN), ISDN equipment, T1 lines, PBX systems and other known transmission systems and methodologies. One technique gaining interest in the telecommunications field is the use of digital versions of voice information transmitted over various networks. An example of such is commonly known as Voice over Internet Protocol (VoIP). Currently available devices and systems for providing Voice over Internet Protocol (VoIP) offer two methodologies, each with its own set of trade-offs between flexibility and efficiency.

A first methodology may be described as that of traditional VoIP. With traditional VoIP, standards were created to insure that equipment from various vendors could communicate successfully for solution deployment. The generally accepted school of thought on traditional VoIP was that it must provide all the features of the regular Public Switched Telephone Network (PSTN) voice traffic. In addition, it must co-exist with other data on networks and provide quality of service (QoS) levels consistent with current toll quality voice.

Such traditional methodology involves the installation of converters (Integrated Access Devices) at locations that convert the analog or digital voice to some form of data, which, more often than not, is a form of compressed data. Call signaling (e.g., DTMF's, call progress tones, etc.) is separated from voice signals and sent in data translations to a “softswitch”. The softswitch mimics the functions of Signaling System 7 (SS7) in the PSTN network, arranging paths and out of band call progress signaling.

This traditional methodology provides for flexibility and feature rich applications, but to provide for such flexibility, additional data, in the form of headers, is added to each data packet. The out of band signaling also requires another level of overhead and complexity. Since efficient bandwidth consumption is an ultimate goal of most telecommunications applications, the trade off is flexibility and features vs. additional bandwidth requirement for every packet.

A second available methodology is one that is generally know as voice over Time Domain Multiplexing (VoTDM), which is a variation of VoIP. The particular acronyms given to this second technology vary, but the functionality is similar. In this methodology flexibility is lost as every phone at a remote site is logically, permanently tied to a specific port at a central platform. In other words, every time phone “A” at facility “F” makes a call, the same port is used centrally. Also, the port at the central platform cannot be used for any other purpose other than to handle a call from phone “A” at facility “F.”

This second methodology provides for the striping of the packets down to the bare routing necessities and none of the traditional VoIP protocol's overhead. The trade off here is efficient bandwidth use vs. loss of flexibility in the form of inefficient use of the central resources.

While various aspects and alternative features are known in the field of voice over Internet Protocol (VoIP) systems, no one design has emerged that generally integrates all of the ideal features and performance characteristics as discussed herein.

### SUMMARY OF THE INVENTION

The present technology recognizes and addresses several of the foregoing shortcomings, and others concerning various aspects associated with voice over Internet Protocol (VoIP) implemented technology. Thus, broadly speaking, the present technology provides for an improved Voice over Internet Protocol (VoIP) based technology. More particularly, the present subject matter functionally provides for improved selective combination of functionality of the two previously discussed methodologies, and thereby provides for an improved and selectable balance of trade off's over capabilities relative to how they previously existed in combination.

Still further, the present technology avoids the use of a “softswitch” as well as traditional VoIP overhead signaling. More particularly, the present technology avoids the problem of being “nailed down” or overly limited, as it does not employ the technique of relying on a set relationship between a facility port and a central port.

In accordance with aspects of certain embodiments of the present technology, data packets are generally formed as are normal IP packets but instead only a single identifier is added to the packet. As will be more fully explained herein, this single identifier is sufficiently provided fore present technology operating in conjunction therewith to achieve a facility/phone data association.

A further aspect of certain embodiments of the present subject matter is to transmit such packets to a host IP address where the packets are distributed according to the current “session” of the phone call. This aspect provides completely reusable central facility ports such that once a call or “session” has ended the central port can immediately be assigned another call or session.

A still further aspect of certain embodiments of the present subject mater is that for redundancy the facility equipment may be assigned at least two host IP addresses. If a session cannot be obtained with the primary host IP address, the secondary host IP address is used, but once a session is initiated, it cannot be moved without breaking the call.

Yet another aspect of certain embodiments of the present subject matter is the efficient appropriation of Digital Signal Processors (DSP's). By far the most costly component of VoIP equipment is the DSP's required for the real time digitization, compression, and formation of voice data packets.

Yet another aspect of the certain embodiments of the present subject matter is the provisioning of the traditional “channel bank” and VoIP processing in the same appliance utilizing the previously mentioned present approach of voice (i.e., audio) data packet formation.

The present subject matter further generally provides for the efficient transmission of voice or audio data within a specialized environment in a manner that permits maximum use of available bandwidth while dispensing with unnecessary components currently included in voice over Internet Protocol (VoIP) systems. More particularly, the present subject matter relates to the transmission of voice information, i.e., voice or audio data, within the specialized environment or context of correctional institutions, using a modified Internet Protocol (IP) to provide a more efficient use of available bandwidth. As a non-limiting example, the remainder of the present disclosure will refer to the transmission of telephone (i.e., audio) conversations within the above noted particular environment and, more particularly, will be directed to an environment wherein a number of telephone instruments are provided within a corrections facility and are configured for telecommunications operations with called parties outside the corrections facility. It is to be strictly understood, however, that the present technology may be applied to and/or used within other areas where transmission of telephone conversations, or other audio or voice data, may be of interest. For example, it may be desirable to provide a number of telephone instruments for use at or within facilities other than corrections facilities and, moreover, such provisioning might be on a temporary basis or more or less permanent basis. Non-limiting examples might include a telephone bank at a public facility such as an airport terminal, a convention arena or other location where significant numbers of people may gather or visit and might have need of telecommunications facilities. Another example might be the temporary installation of a number of telephone instruments at a particular location. Non-limiting examples of such temporary installations may include large sporting events, short term outdoor gatherings and events, large conventions at facilities where existing telecommunications equipment may be inadequate, or other types of events or circumstances where the temporary provisioning of telecommunications equipment may be desired.

Additional aspects and advantages of the present subject matter are set forth in, or will be apparent to those of ordinary skill in the art from, the detailed description herein. Also, it should be further appreciated by those of ordinary skill in the art that modifications and variations to the specifically illustrated, referenced, and discussed features and steps hereof may be practiced in various embodiments and uses of this subject matter without departing from the spirit and scope thereof, by virtue of present reference thereto. Such variations may include, but are not limited to, substitution of equivalent means and features, materials, or steps for those shown, referenced, or discussed, and the functional, operational, or positional reversal of various parts, features, steps, or the like.

Still further, it is to be understood that different embodiments, as well as different presently preferred embodiments, of this subject matter may include various combinations or configurations of presently disclosed features, steps, or elements, or their equivalents (including combinations of features or steps or configurations thereof not expressly shown in the figures or stated in the detailed description).

One exemplary embodiment of the present subject matter relates to improved apparatus and corresponding methodology for providing efficient voice or audio data transmission over ethernet connections.

Another, more particular exemplary embodiment of the present technology relates to improved apparatus and corresponding methodology for providing a telecommunications system enabling maximum use of available bandwidth by providing a unique VoIP solution for certain specialized environments.

One present exemplary embodiment may comprise a telephone system, preferably having a plurality of proximally located analog telephone instruments, with an access device coupled to each of such instruments. Preferably, such access device in turn will have an analog to digital converter, a voice packet former, and a voice packet transmitter. Such exemplary telephone system may further have a remote data receiver configured to receive voice packets transmitted from the voice packet transmitter.

With the foregoing exemplary telephone system, the voice packet former may be configured so as to associate a unique analog telephone instrument identifier with digital data from the analog to digital converter. As further optional aspects thereof, the voice packet transmitter may be configured to transmit the voice packets wirelessly to the remote data receiver, and it may optionally comprise an ethernet interface. Still further options may include providing a wide area network (such as the Internet) coupling the voice packet transmitter to the remote data receiver. In such an exemplary system, also the telephone system remote data receiver may be configured to transmit received voice packets to the access device so as to provide local telephone service from one of the plurality of proximally located analog telephone instruments to another analog telephone instrument remote therefrom. Similarly, the remote data receiver may be further configured to transmit voice packets to the public switched telephone network to provide long distance telephone service for selected ones of the plurality of proximally located analog telephone instruments. More particularly in such example, the access device may further comprise a data compressor, and may still further comprise a processor, and a digital signal processor, so that the processor cooperates with the digital signal processor to provide the analog to digital converter, the voice packet former and the data compressor. Such an access device may further comprise a signal line interface circuit, a T-1 interface circuit, a serial port and a data network interface.

Still further present exemplary embodiments may involve a specialized phone system for use in relation to a prison environment, and may include a plurality of proximally located analog telephone instruments at a first location situated within a prison facility, and an access device coupled to each of such instruments. The exemplary access device per such embodiment of the present subject matter may comprise an analog to digital converter, a voice packet former, and a voice packet transmitter. Such overall specialized phone system may include also a remote data receiver configured to receive voice packets transmitted from the voice packet transmitter, with the voice packet former configured to associate a unique analog telephone instrument identifier with digital data from the analog to digital converter. In such fashion, inmate conversations conducted by way of the telephone instrument may be efficiently conducted to locations physically remote from the prison facility.

Those of ordinary skill in the art will appreciate from the complete disclosure herewith that such a specialized phone system embodiment may include optional additional features, similar in the manner of the exemplary phone system above, per the needs of given circumstances, and in accordance with the broader teachings herewith.

Likewise, it will be understood by those of ordinary skill in the art that the present subject matter equally pertains to corresponding methodology and other method embodiments, for practicing the present subject matter. One exemplary such method involves a method of transmitting voice data, comprising the steps of converting analog voice signals to digital data, forming voice packets by attaching a unique identifier to the digital data created in the step of converting (such unique identifier identifying the source of the analog voice data), and transmitting the voice packets to a data center. With such an exemplary method, optionally further, prior to the step of transmitting, the digital data may be compressed. The step of transmitting may comprise transmitting the data packets wirelessly or over an Ethernet. Such an Ethernet may comprise a wide area network or the Internet. Still further, such exemplary method may involve providing a plurality of analog telephone instruments at a predetermined location, and associating a unique identifier with each individual instrument of such plurality of analog telephone instruments.

Another present exemplary method involves a method for operating a telephone bank, comprising the steps of providing a plurality of proximally located telephone instruments, assigning a unique digital identifier to each of such plurality of proximally located telephone instruments, converting voice frequency audio signals from selected of such plurality of proximally located telephone instruments into digital data; associating the unique digital identifier from the selected of such plurality of proximally located telephone instruments with the digital data from the step of converting to form voice packets, and transmitting voice packets associated with each of such plurality of proximally located telephone instruments to a common remote data receiver.

Still further, exemplary present methodology may involve a method of transmitting audio data, comprising the steps of converting analog audio signals so as to form digital data corresponding thereto, forming voice packets by attaching a unique identifier to such digital data formed in the converting step, with such unique identifier identifying the source of the analog audio signals, and transmitting said voice packets to a data center. Optionally, such exemplary method may involve providing a plurality of analog telephone instruments at a predetermined location, and associating a unique identifier with each individual instrument of such plurality of analog telephone instruments.

Additional embodiments of the present subject matter, not necessarily expressed in this summarized section, may include and incorporate various combinations of aspects of features, parts, or steps referenced in the summarized aspects above, and/or features, parts, or steps as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a representative illustration of a voice (or audio) data packet commonly used with Voice over Internet Protocol (VoIP) systems;

FIG. 2 is a representative illustration of a voice (or audio) data packet according to an exemplary embodiment of the present subject matter;

FIG. 3 is a generally representational block diagram illustrating a telecommunications system employing voice data packets as illustrated in FIG. 2 in accordance with the present subject matter; and

FIG. 4 is a generally representational block diagram illustrating features within the Integrated Access Device (IAD) of FIG. 3 in accordance with an exemplary embodiment of the present subject matter.

Repeat use of reference characters throughout the present specification and appended drawings is intended to represent same or analogous features, elements or steps of the present subject matter.

### DETAILED DESCRIPTION OF THE DRAWINGS

As referenced in the Summary of the Invention section, supra, the present subject matter is directed towards improved apparatus and corresponding methodology for the transmission of voice or audio information, i.e., voice or audio data, within a specialized environment using a modified Voice over Internet Protocol (VoIP) to provide more efficient use of available bandwidth.

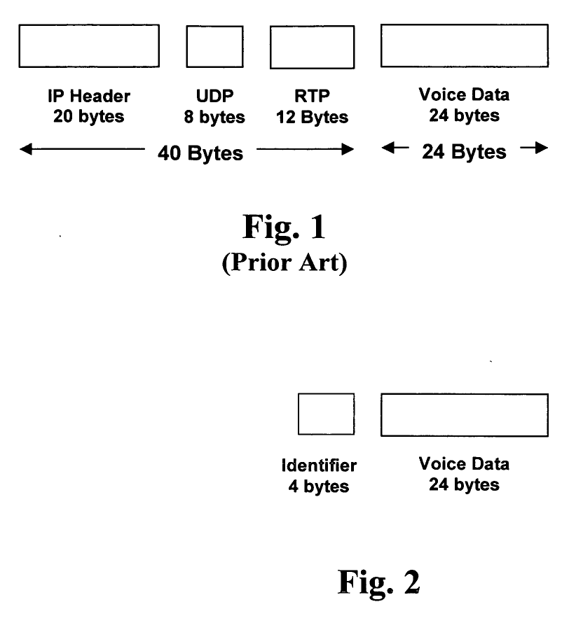

With reference to FIG. 1, previously existing Voice over Internet Protocol (VoIP) technology provides coded voice data assembled into packets as it is being prepared for transportation over a wide area network (WAN).

Although not required for practice of the presently disclosed technology, the WAN may consist of the Internet, but may equally consist of a wide area network not directly connected, although possibly connectable, to the Internet. Variations of such aspect of the present subject matter are known to those of ordinary skill in the art, and form no particular aspect of the present subject matter. Such variations may also include partial or full use of an intranet; a local area network (LAN) that may include optical, wired and/or wireless (e.g., WiFi) connections; and/or any subsequently developed technology, even though not presently in existence, for forming such transport aspects of the present broader subject matter.

With continued reference to FIG. 1, a Transmission Control Protocol/Internet Protocol (TCP/IP) protocol stack, using User Datagram Protocol (UDP) and Real Time Protocol (RTP) executes the process of providing header information for association with digitized voice data. Such protocols improve delivery of the voice data within an Internet Protocol (IP) system.

A typical IP telephone data packet starts with the so-called IP, UDP, and RTP headers. Typically, the various headers combine to total 40 bytes. These headers contain protocol information needed to properly transport the voice data over the IP telephone system. Included in this protocol information are data such as the source and destination IP addresses, the IP port number, the packet sequence number, and the like, as well known to one of ordinary skill in the art. An important consideration for an IP Telephony network is whether one or more frames of coded voice data follow the headers. Using a G.723.1 coder (which produces 24 byte frames every 30 milliseconds) as an example, each packet would have only 24 bytes of data to 40 bytes of header. Thus, the header would constitute 62.5% of the entire packet.

In accordance with the present subject matter, a significant savings in “overhead” (i.e., required header) has been achieved, and thus a significant increase in voice (or audio) data transport is possible over previous VoIP systems using the same available bandwidth. More particularly, the present subject matter recognizes that in the specialized environment of the present technology, a great deal of the traditional functionality and associated overhead is wasted, as it is not needed. As previously noted, VoIP standards were created to insure that equipment from various vendors could communicate successfully with one another, for solution deployment. The then prevailing understanding was that traditional VoIP must provide all the features of the regular PSTN voice traffic and it must co-exist with other data on networks while providing quality of service (QoS) levels consistent with toll quality voice currently experienced. The traditional approach is to install converters (Integrated Access Devices) at locations that convert the analog or digital voice to some form of data that is usually compressed data. The call signaling (i.e., DTMF's, call progress tones) are separated from the voice or audio data and sent in data translations to a “softswitch”. The softswitch, mimics the functions of SS7 in the PSTN network, arranging paths and out of band signaling.

In accordance with the present subject matter, every call from every location is directed to the same location, a central data center. All call progress tones are detected on the “other side” of established connections with the exception of DTMF's and calling party hang up. Given such parameters established per the present technology, the overhead of VoIP is completely unnecessary. Specific examples are the UDP that normally specifies how packets are formed becomes unnecessary as every packet is formed the same way and has the same payload. The RTP becomes unnecessary as every packet is formed in real time and has the same priority. The softswitch requires no routing information to control its operation as every call is routed over the same path every time. In this light and because of the various specialized environments in which the present technology may be advantageously employed, only a basic IP header and no out of band signaling is required. Removing the VoIP protocols (more specifically, by not initially providing them) from such packets provides for much more efficient bandwidth utilization, thus significantly reducing costs.

With reference now to FIG. 2, an exemplary embodiment is illustrated for the voice or audio data packet formation of the present subject matter. As seen in FIG. 2, the present subject matter provides a significantly reduced “header” and, consequently, much more efficiently uses the available bandwidth. More specifically, in an exemplary embodiment, the present subject matter provides a voice packet consisting of compressed voice data and a “hex base 32” character that is used to uniquely identify individual telephones within the system. In this exemplary embodiment, this four-byte character provides for up to four billion unique identifiers. Maintaining the same 24 bytes of compressed voice data in each packet as used in conventional VoIP systems, while adding only a four-byte header (per present subject matter), produces a packet wherein the header information constitutes only 14.3% of the total packet. Thus, the practice of the present subject matter results in providing a significant increase in voice (or audio) data transport capability using the same bandwidth as conventional VoIP systems.

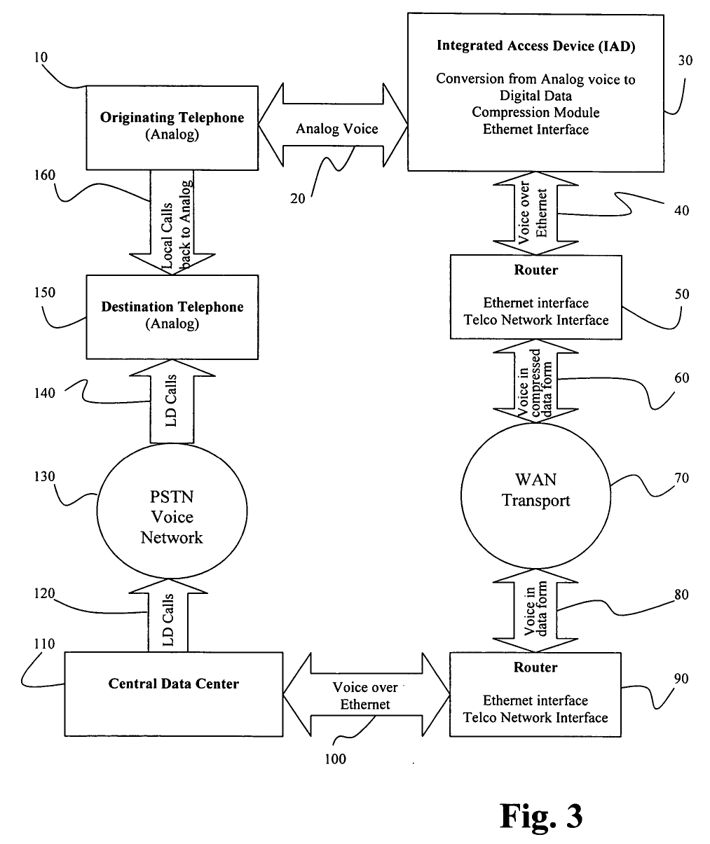

With reference to FIG. 3, a specific example is illustrated of a system using the voice or audio packets of the present subject matter. In the context of the exemplary environment of a corrections facility, a standard, analog telephone 10 is provided at the facility for use by inmates and other detainees. As a general proposition for some embodiments, both local and long distance calls may be originated from telephone 10. Although no special electronic equipment may be required in provisioning telephone 10 per se, logistically a special housing may be provided to protect telephone 10 from potentially abusive handling.

It should be appreciated and understood that although a single telephone 10 is illustrated, such is merely representative of one or more telephone instruments that may be provided at the facility. Where a plurality of telephone instruments are provided at a single facility, a channel bank may be provided as a part of Integrated Access Device (IAD) 30 to convert the analog voice signals from a plurality of standard analog telephones 10 to a digital T-1 interface. The IAD 30 of the present subject matter may incorporate both the channel bank functionality and a Voice over Packet (VoP) functionality, as will be more fully described later.

IAD 30 includes an analog to digital converter and may also provide digital voice compression (e.g., G.723.1a). In addition, IAD 30 in accordance with present subject matter supplies a unique header for each voice packet. As previously discussed with reference to FIG. 2, each such packet is formed by associating (possibly) compressed voice or audio data and a “hex base 32” character to uniquely identify each telephone 10 in the system. This four-byte character is placed in the header of each voice or audio packet and, coupled with the same logic applied centrally to each incoming packet, produces a packet that is self identifying, thus removing any requirement of port association as in prior VoIP configurations.

IAD 30 may also include in this exemplary embodiment an Ethernet Interface that couples the digitized voice data packets via Ethernet 40 to router 50. Router 50 includes an appropriate Telecom Network Interface based on the installation (e.g., Frame Relay, ATM, MPLS, etc.) that couples the voice or audio data packets by way of Ethernet 60 to a WAN 70 and then to Ethernet 80 and on to Router 90 that may be co-located with a Central Data Center 110, so coupled and directed, all based on the IP address alone. As previously noted, the particular configuration of the WAN transport mechanism is not critical to the present subject matter in that transport of voice data packets may be put into effect over any presently known or subsequently developed data transport mechanisms or methodologies. These may include optical, wired, or wireless transmission mediums and may be embodied as local area networks (LAN), wide area networks (WAN), intranets, the Internet, or any other suitable (i.e., technically sufficient) transmission mechanism.

Such indicated exemplary second Router 90 may be provided at the Central Data Center 110 location to again provide an interface to the telecom network, converting the voice packets back to Ethernet.

The Central Data Center 110 accepts the voice (or audio) data packets over the Ethernet 100 by way of an interface card within the Central Data Center 110. The telephone call (per the present exemplary embodiment) is then processed as required depending on the particular installation. In the corrections environment, such processing may include such as verification of personal identification number (PIN), determination of whether the call meets time of day, destination, call type or other restrictions as well as whether the conversation is to be recorded. If during the call processing the Central Data Center 110 determines that the call is a local type call, the call is routed back over a different channel on the same equipment path to the facility from which the call was placed. The call is then sent out over a local line at the facility. If the Central Data Center 110 determines that the ultimate call connection intended to be made is long distance from the facility, it is routed through an outbound port to a long distance carrier's network for termination. Of course, both such exemplary actions assume that any other criteria for call screening (e.g., call blocking or permitting and/or recording) as applicable to permitting such calls (either locally or long distance) has been satisfied (which aspects of control protocol form no particular aspects of the present subject matter).

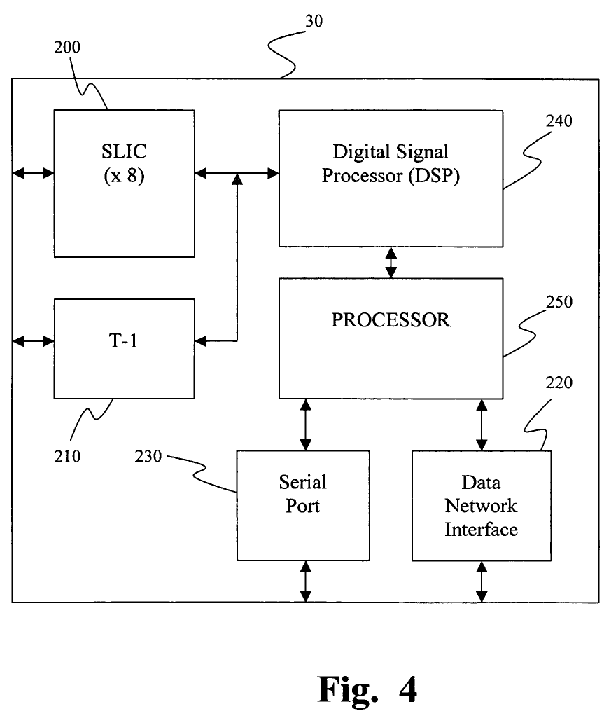

With reference now to FIG. 4, a generally representational block diagram is shown illustrating features of an Integrated Access Device 30 (IAD) for use with the present subject matter.

Exemplary IAD 30 is configured for installation at a facility site and serves to convert analog and/or digital voice or audio to a highly compressed data form. The highly compressed data produced will then interface with a router providing data circuits back to control data center 110. At the control data center 110 the data will be de-compressed and translated before entering a network based private branch exchange (PBX) system.

Exemplary IAD 30 includes an analog input including a conventional plain old telephone system (POTS) foreign exchange station (FXS) line interface. A single line interface card 200 (SLIC) may be bundled into eight (8) port cards that may be inserted to produce a maximum of ninety-six (96) total ports. IAD 30 may also include an optional digital input 210 on the local telephone side of the IAD 30. An actual physical connection to the IAD 30 for the optional digital input may be completed by way of a standard RJ-45 jack.

As interface elements to the IAD 30, both a data network interface 220 and a serial port 230 may be provided. The data network interface 220 may be provided as an Ethernet interface and includes an Internet Protocol (IP) stack. Serial Port 230 may be provided as an input port for local configuration of the IAD 30.

Digital Signal Processor (DSP) 240 provides support for data compression and de-compression, DTMF generation and IP encapsulation of the compressed data for transmission to the control data center 110.

Finally, processor 250 is provided with an operating system (OS) and firmware to control the overall operation of IAD 30. The firmware contained in processor 250 is also designed to provide an interface for system configuration including provision of telecommunication port assignments and Ethernet configuration including IP assignment.

Thus, there has been described apparatus and methodology for providing improved bandwidth efficiency in a centralized data center voice over IP system, the provisioning of which results in a VoIP arrangement with greatly increased voice (or audio) data transporting capability over that of similar systems using similar bandwidth.

While the present subject matter has been described in detail with respect to specific embodiments thereof, it will be appreciated that those skilled in the art, upon attaining an understanding of the foregoing, may readily produce alterations to, variations of, and/or equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

1. A method of transmitting voice data, comprising the steps of:
converting analog voice signals to digital data;
forming voice packets by attaching a unique identifier to the digital data created in the step of converting, said unique identifier identifying the source of the analog voice data; and
transmitting the voice packets to a data center.

2. The method of claim 1, further comprising the step of:
compressing the digital data formed in the step of converting prior to the step of transmitting.

3. The method of claim 1, wherein the step of transmitting comprises transmitting the data packets wirelessly.

4. The method of claim 1, wherein the step of transmitting comprises transmitting the data packets over an ethernet.

5. The method of claim 4, wherein the ethernet comprises a wide area network.

6. The method of claim 4, wherein the ethernet comprises the Internet.

7. The method of claim 1, further comprising the steps of:
providing a plurality of analog telephone instruments at a predetermined location; and
associating a unique identifier with each individual instrument of said plurality of analog telephone instruments.

8. A telephone system, comprising:
a plurality of proximally located analog telephone instruments;
an access device coupled to each of said instruments, said access device comprising an analog to digital converter, a voice packet former, and a voice packet transmitter; and
a remote data receiver configured to receive voice packets transmitted from said voice packet transmitter.

9. The telephone system of claim 8, wherein the voice packet former is configured to associate a unique analog telephone instrument identifier with digital data from said analog to digital converter.

10. The telephone system of claim 8, wherein the voice packet transmitter is configured to transmit the voice packets wirelessly to the remote data receiver.

11. The telephone system of claim 8, wherein the voice packet transmitter comprises an ethernet interface.

12. The telephone system of claim 11, further comprising a wide area network coupling the voice packet transmitter to the remote data receiver.

13. The telephone system of claim 12, wherein said wide area network comprises the Internet.

14. The telephone system of claim 9, wherein said remote data receiver is configured to transmit received voice packets to said access device to provide local telephone service from one of said plurality of proximally located analog telephone instruments to another of said plurality of proximally located analog telephone instruments.

15. The telephone system of claim 14, wherein said remote data receiver is further configured to transmit voice packets to the public switched telephone network to provide long distance telephone service for selected ones of the plurality of proximally located analog telephone instruments.

16. The telephone system of claim 8, wherein said access device further comprises a data compressor.

17. The telephone system of claim 16, wherein said access device comprises a processor, and a digital signal processor, and wherein said processor cooperates with said digital signal processor to provide said analog to digital converter, said voice packet former and said data compressor.

18. The telephone system of claim 17, wherein said access device further comprises a signal line interface circuit, a T-1 interface circuit, a serial port and a data network interface.

19. A method for operating a telephone bank, comprising the steps of:
providing a plurality of proximally located telephone instruments,
assigning a unique digital identifier to each of said plurality of proximally located telephone instruments;
converting voice frequency audio signals from selected of said plurality of proximally located telephone instruments into digital data;
associating the unique digital identifier from the selected of said plurality of proximally located telephone instruments with the digital data from the step of converting to form voice packets; and
transmitting voice packets associated with each of said plurality of proximally located telephone instruments to a common remote data receiver.

20. A specialized phone system for use in relation to a prison environment, comprising:
a plurality of proximally located analog telephone instruments at a first location situated within a prison facility;
an access device coupled to each of said instruments, said access device comprising an analog to digital converter, a voice packet former, and a voice packet transmitter; and
a remote data receiver configured to receive voice packets transmitted from said voice packet transmitter;
wherein said voice packet former is configured to associate a unique analog telephone instrument identifier with digital data from said analog to digital converter, whereby inmate conversations conducted by way of said telephone instrument may be efficiently conducted to locations physically remote from said prison facility.

21. The specialized phone system of claim 20, wherein said voice packet transmitter is configured to transmit said voice packets wirelessly to said remote data receiver.

22. The specialized phone system of claim 20, wherein said voice packet transmitter comprises an ethernet interface.

23. The specialized phone system of claim 22, further comprising a wide area network coupling said voice packet transmitter to said remote data receiver.

24. The specialized phone system of claim 23, wherein said wide area network comprises the Internet.

25. The specialized phone system of claim 20, wherein said remote data receiver is configured to transmit received voice packets to said access device to provide local telephone service from one of said plurality of proximally located analog telephone instruments to another telephone instrument not located at said prison facitily.

26. The specialized phone system of claim 25, wherein said remote data receiver is further configured to transmit voice packets to the public switched telephone network to provide long distance telephone service for selected ones of the plurality of proximally located analog telephone instruments.

27. The specialized phone system of claim 20, wherein said access device further comprises a data compressor.

28. The specialized phone system of claim 27, wherein said access device comprises a processor, and a digital signal processor, and wherein said processor cooperates with said digital signal processor so as to provide said analog to digital converter, said voice packet former and said data compressor.

29. The specialized phone system of claim 28, wherein said access device further comprises a signal line interface circuit, a T-1 interface circuit, a serial port and a data network interface.

30. A method of transmitting audio data, comprising the steps of:
converting analog audio signals so as to form digital data corresponding thereto;
forming voice packets by attaching a unique identifier to said digital data formed in said converting step, said unique identifier identifying the source of the analog audio signals; and
transmitting said voice packets to a data center.

31. The method of claim 30, further comprising the step of:
prior to said transmitting step, compressing said digital data formed in said converting step.

32. The method of claim 30, wherein said transmitting step comprises one of transmitting said data packets wirelessly, or over an ethernet.

33. The method of claim 30, wherein the step of transmitting comprises transmitting the data packets over an ethernet, wherein the ethernet comprises a wide area network.

34. The method of claim 30, wherein the step of transmitting comprises transmitting the data packets over an ethernet, wherein the ethernet comprises the Internet.

35. The method of claim 30, further comprising the steps of:
providing a plurality of analog telephone instruments at a predetermined location; and associating a unique identifier with each individual instrument of said plurality of analog telephone instruments.
